(19) United States
(12) Patent Application Publication
(10) Pub. No.: US 2010/0006392 A1
(43) Pub. Date: Jan. 14, 2010

(54) Device for conveying a workpiece

(76) Inventor: Karl WEINMANN, St. Johann (DE)

Correspondence Address: MICHAEL J. STRIKER, 103 EAST NECK ROAD, HUNTINGTON, NY, 11743, US

(21) Appl. No.: 12/498,428

(22) Filed: Jul. 7, 2009

(30) Foreign Application Priority Data
Jul. 9, 2008 (DE) 10 2008 032 302.0

(51) Int. Cl. B65G 47/90

(52) U.S. Cl. 198/346.2

(57) ABSTRACT

A device for conveying a workpiece from a processing station and/or to a processing station, has a gripping device with gripping jaws which reach over the workpiece and move it along a conveying device from the processing station and/or to a processing station; the gripping jaws which reach over the workpiece are situated on a carrier in such a manner that the distance between them is adjustable, and at least one processing tool for the workpiece is also situated on the carrier.

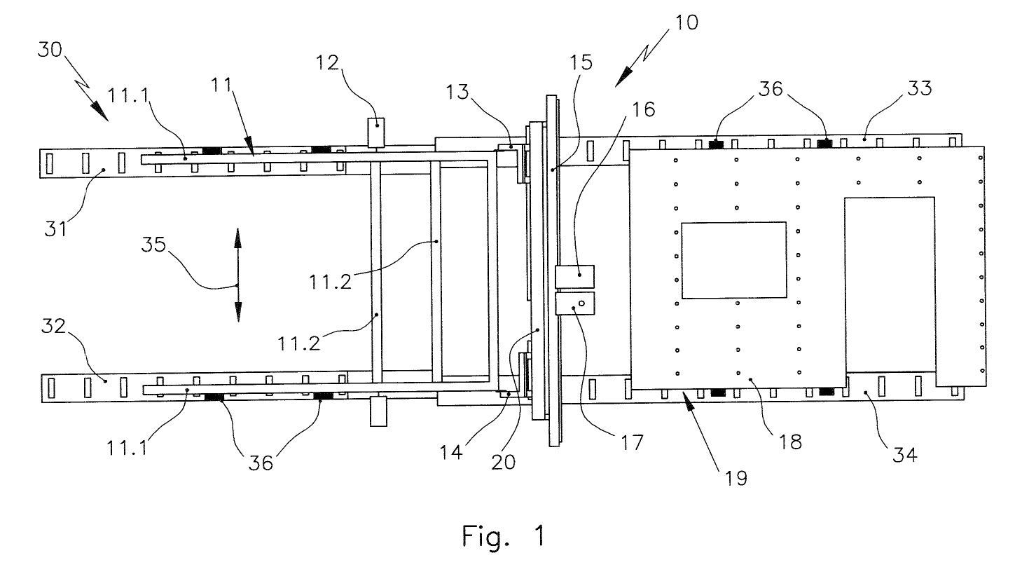

### CROSS-REFERENCE TO RELATED APPLICATION

The invention described and claimed hereinbelow is also described in DE 10 2008 032 302.0 filed on Jul. 9, 2008. This German Patent Application, whose subject matter is incorporated here by reference, provides the basis for a claim of priority of invention under 35 U.S.C. 119(a)-(d).

### BACKGROUND OF THE INVENTION

The present invention relates to devices for conveying workpieces. More particularly, the present invention relates to a device for conveying a workpiece from a processing station, which includes a gripping device having gripping jaws which reach over the workpiece and move it along a conveying device from a processing station and/or to a processing station; the gripping jaws which reach over the workpiece are situated on a carrier in such a manner that the distance between them is adjustable.

Feeding and removing devices of this type are known, in particular for use with longitudinal workpieces such as bars, tubes, or plates. They grip the workpiece and move it in a cyclical or continual manner out of the processing station and guide it to a processing station. Since the gripping jaws are situated on a carrier having an adjustable length, these devices may be used to grip and convey workpieces having different widths.

The known devices are pure gripping and conveying devices that are used only to move a workpiece from a processing station or to a processing station or between processing stations.

For workpieces on which different types of processing will be carried out, the amount of time taken to convey and transport the workpieces between the processing stations must be minimized to the greatest extent possible in order to make production efficient.

### SUMMARY OF THE INVENTION

The object of the present invention, therefore, is to develop a device of the type described initially in such a manner that it enables the total processing time for the workpiece to be shortened.

The object is attained via a device for conveying a workpiece from a processing station and/or to a processing station, which includes a gripping device having gripping jaws which reach over the workpiece and move it along a conveying device from a processing station and/or to a processing station; the gripping jaws which reach over the workpiece are situated on a carrier in such a manner that the distance between them is adjustable; the device is characterized by the fact that at least one processing tool for the workpiece which is movable between the gripping jaws is also situated on the carrier.

The device according to the present invention is therefore used not only to convey a workpiece from and/or to a processing station, it also makes it possible to process the workpiece being conveyed. In this manner, the conveying time may be used to process the workpiece, thereby ensuring that the conveying time is not dead time in the manufacturing process. In addition, individual stationary processing stations may be eliminated if the processing steps carried out there may be taken over by the conveying device. The carrier of the gripping device of the conveying device according to the present invention is used similarly to the portal of a tool portal machine.

It is advantageous when the at least one processing tool is situated such that it may be displaced longitudinally along the carrier. The at least one processing tool may be used transversely to the conveying direction at every desired point on the workpiece.

Further advantages result when the device may be moved, with the gripping jaws open, outside of the processing station along the conveying device and past the workpiece. As a result, it is possible to also process different points of the workpiece in the direction of conveyance of the workpiece. The motions of the device with the gripping jaws open may be carried out during pauses in conveyance. Using a design of this type, the conveying device may replace a tool portal machine.

In a preferred embodiment, the at least one processing tool may also be actuated with the gripping jaws open and/or closed. This makes it possible to process a workpiece while it is being conveyed or while it is not being conveyed, thereby resulting in a further reduction in the time required to process the workpiece.

For more complex tasks, it is also advantageous to provide at least one multiple-axle tool assembly having a tool changer, as the processing tool. This makes it possible to process all sides of the workpiece using different tools.

All tools that are required to manufacture the workpiece may be used in principle as the processing tools. For example, router bits, drills, and screwdriver devices may be provided as the processing tools. Sawing or nailing and clamping devices may also be situated on the carrier.

The precision of the processing steps may be increased when the at least one processing tool is CNC-controlled.

In addition to the gripping jaws, additional fixing devices for the workpiece may be provided. Pressing devices may be located on the carrier, for example, using which the workpiece may be pressed against the conveying device while it is being processed by the at least one processing tool. As a result, it is possible to prevent the workpiece from becoming accidentally lifted off of the conveying device.

Various possibilities exist for the design of the conveying device. According to a preferred embodiment, the conveying device may include at least one roller track on which the workpiece is situated. Using roller tracks, it is possible to convey workpieces in a relatively frictionless manner while providing them with good support from below.

In addition, the width of the conveying device may be adjustable, and it may include devices for clamping the workpiece. This is advantageous in particular when long workpieces are involved, or when the workpiece is to be processed not only with the gripping jaws closed. In these cases, the clamping devices of the conveying device hold the workpiece securely, while the at least one processing tool may be used at any desired point on the workpiece.

Basically, the conveying device according to the present invention may be used advantageously for a large number of workpieces. Longitudinal and flat workpieces in particular may be conveyed and processed in an excellent manner using this device. Possible workpieces include, in particular, a bar, a plate, vertical members for a wall element, or a wall element.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

The single FIGURE of the drawings is a top view showing a device for conveying a workpiece in accordance with the present invention.

### DESCRIPTION OF THE PREFERRED EMBODIMENTS

In accordance with the present invention a conveying device 10 is provided for a vertical member 11 of a wall element.

In this case, the workpiece therefore has the shape of a vertical member 11 which is manufactured out of longitudinal bars 11.1 and transverse bars 11.2 by a processing station 12 designed as a nailing device.

The conveying device includes a gripping device 20 having gripping jaws 13, 14; gripping device 20 is attached to a carrier 15. The gripping jaws are situated such that they are displaceable in the longitudinal direction of carrier 15. In this manner, the distance between gripping jaws 13, 14 may be adjusted to accommodate workpieces 11 having different widths, i.e. vertical members having different heights in this case. In addition, two processing tools 16, 17 are situated on carrier 15, one of which is a nailing device 17, and the other of which is a pressing device 16.

Using processing tools 16, 17 which are displaceable along carrier 15, a plate-shaped element 18 may be nailed to bars 11.1 and 11.2 on vertical member 11 on the removal side of processing station 12, thereby producing a wall element 19. While nailing is being carried out using tool 17, pressing device 16 presses plate-shaped element 18 against bars 11.1, 11.2 in order to hold it in place during processing.

In the example shown, conveying device 20 for vertical members 11 is formed by two roller tracks 31, 32 on the feed side of processing station 12, and it is formed by two roller tracks 33 and 34 on the removal side. The distance between roller tracks 31, 32 and 33, 34 is adjustable, as indicated by double arrow 35.

In addition, stops 36 are provided on roller tracks 31, 32; 33, 34, using which and via the adjustability of the distance between roller tracks 31, 32; 33, 34, workpiece 11 may be clamped on the feed side and on the removal side.

It will be understood that each of the elements described above, or two or more together, may also find a useful application in other types of constructions differing from the types described above.

While the invention has been illustrated and described as embodied in a device for conveying a workpiece, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A device for conveying a workpiece from a processing station and/or to a processing station, comprising a conveying device; a gripping device having gripping jaws reachable over the workpiece and moving it along said conveying device from the processing station and/or to a processing station; a carrier on which said gripping jaws that reach over the workpiece are situated in such a manner that a distance between said grinning jaws is adjustable; and at least one processing tool for the workpiece, which is movable between said gripping jaws and also situated on said carrier.

2. The device as defined in claim 1, wherein said at least one processing tool is situated such that it is displaceable along said carrier.

3. The device as defined in claim 1, wherein the device for conveying the workpiece is movable along said conveying device and past the workpiece.

4. The device as defined in claim 1, wherein said at least one processing tool is actuatable while said gripping jaws are in a position selected from the group consisting said gripping jaws are open, said gripping jaws are closed, and both.

5. The device as defined in claim 1, wherein said at least one processing tool is configured as at least one multiple-axle tool assembly having a tool changer.

6. The device as defined in claim 1, wherein said at least one processing tool is composed as a tool selected from the group consisting of a router bit, a drill, and a screwdriver.

7. The device as defined in claim 1, further comprising means for CNC-controlling said at least one processing tool.

8. The device as defined in claim 1, further comprising fixing devices provided for the workpiece and situated on said carrier.

9. The device as defined in claim 8, wherein said fixing devices are configured as pressing devices.

10. The device as defined in claim 1, wherein said conveying device includes at least one roller track on which the workpiece is situatable.

11. The device as defined in claim 1, wherein said conveying device has a width which is adjustable, and includes devices for clamping the workpiece.

12. The device as defined in claim 1, wherein the device for conveying a workpiece is formed so that it can convey the workpiece selected from the group consisting of a bar, a plate, vertical members for a wall element, and a wall element.
